(19) United States
(12) Patent Application Publication
(10) Pub. No.: US 2022/0080373 A1
(43) Pub. Date: Mar. 17, 2022

(54) MONITORING FEEDBACK SYSTEM AND MONITORING FEEDBACK METHOD

(71) Applicant: CHANGXIN MEMORY TECHNOLOGIES, INC., Hefei City (CN)

(72) Inventor: Wen GU, Hefei City (CN)

(21) Appl. No.: 17/455,965

(22) Filed: Nov. 22, 2021

Related U.S. Application Data
(63) Continuation of application No. PCT/CN2021/103804, filed on Jun. 30, 2021.

(30) Foreign Application Priority Data
Sep. 14, 2020 (CN) 202010962714.6

(51) Int. Cl. B01F 35/22; B01F 35/83; B01F 35/21; B01F 35/213; B01F 35/221

(52) U.S. Cl. CPC B01F 35/2202; B01F 35/832; B01F 35/833; B01F 35/213; B01F 35/2218; B01F 35/2132

(57) ABSTRACT

Disclosed are a monitoring feedback system and a monitoring feedback method. System comprises: a first accommodating device and a second accommodating device, respectively configured to store a first solution and a second solution; a mixing device, configured to store a mixed solution, the mixed solution being composed of the first solution and the second solution; a first concentration detecting device, configured to detect a current concentration of the mixed solution; and a concentration compensating module, configured to obtain, based on a difference between the current concentration and a predetermined concentration, a first compensation amount of the first solution to be compensated to the mixing device or a second compensation amount of the second solution to be compensated to the mixing device, and to compensate the mixed solution based on the first compensation amount or the second compensation amount so that the concentration of the compensated solution reaches the predetermined concentration.

### CROSS-REFERENCE TO RELATED APPLICATIONS

This application is a continuation application of International Patent Application No. PCT/CN2021/103804, filed on Jun. 30, 2021, which claims priority to Chinese Patent Application No. 202010962714.6, filed with the Chinese Patent Office on Sep. 14, 2020 and entitled “MONITORING FEEDBACK SYSTEM AND MONITORING FEEDBACK METHOD.” International Patent Application No. PCT/CN2021/103804 and Chinese Patent Application No. 202010962714.6 are incorporated herein by reference in their entireties.

### TECHNICAL FIELD

The present disclosure relates to the field of semiconductors, and in particular to a monitoring feedback system and a monitoring feedback method.

### BACKGROUND

At present, in a traditional solution mixing process, during detection for a concentration of mixed solution, i.e., a solution obtained after the mixing, if the concentration of the mixed solution is a predetermined concentration, the mixed solution is stored; if the concentration of the mixed solution is not the predetermined concentration, the mixed solution is disposed of as waste solution, and then the solution mixing process is carried out again.

It is not often to obtain the required concentration at a time through the traditional solution mixing process, and solution proportioning needs to be repeated several times. In this process, additional chemicals are required for disposing of the waste solution, and moreover the potential safety hazards caused by the solution mixing operation need to be handled.

### SUMMARY

The objective of the present disclosure is to provide a monitoring feedback system and a monitoring feedback method, which is beneficial to improving the success rate of solution mixing.

In order to solve the above problems, the present disclosure provides a monitoring feedback system, including: a first accommodating device and a second accommodating device, respectively configured to store a first solution and a second solution; a mixing device, configured to store a mixed solution, the mixed solution being composed of the first solution and the second solution; a first concentration detecting device, configured to detect a current concentration of the mixed solution; and a concentration compensating module, configured to obtain, based on a difference between the current concentration and a predetermined concentration, a first compensation amount of the first solution to be compensated to the mixing device or a second compensation amount of the second solution to be compensated to the mixing device, and to compensate the mixed solution based on the first compensation amount or the second compensation amount so that the concentration of the compensated solution reaches the predetermined concentration.

Correspondingly, an embodiment of the present disclosure further provides a monitoring feedback method, including: obtaining a current concentration of a mixed solution, the mixed solution being composed of a first solution and a second solution;

and based on a difference between the current concentration and a predetermined concentration, obtaining a first compensation amount of the first solution to be compensated to the mixing device or a second compensation amount of the second solution to be compensated to the mixed solution, and compensating the mixed solution based on the first compensation amount or the second compensation amount so that the concentration of the compensated solution reaches the predetermined concentration.

### BRIEF DESCRIPTION OF DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIGS. 1 to 2 are schematic structural diagrams of a monitoring feedback system according to a first embodiment of the present disclosure;

FIGS. 3 to 4 are schematic structural diagrams of a monitoring feedback system according to a second embodiment of the present disclosure; and

FIG. 5 is a schematic step diagram of a monitoring feedback method according to a third embodiment of the present disclosure.

### DESCRIPTION OF EMBODIMENTS

It is known from the background section that the solution mixing method in a prior art needs to be improved. In the prior art, in order to obtain a mixed solution, two solutions need to be mixed and a current concentration of a resulting mixed solution is then detected. If the current concentration of the mixed solution is a predetermined concentration, the mixed solution is stored for use in the next step; or, if the current concentration of the mixed solution is not the predetermined concentration, the mixed solution needs to be disposed of in the form of waste liquid. When the waste liquid is disposed of, new chemical consumption will be generated, resulting in additional costs and potential safety hazards caused by the operation.

In order to solve the above problems, an embodiment of the present disclosure provides a monitoring feedback system, including: a first accommodating device and a second accommodating device, respectively configured to store a first solution and a second solution; a mixing device, configured to store a mixed solution, the mixed solution being composed of the first solution and the second solution; a first concentration detecting device, configured to detect a current concentration of the mixed solution; and a concentration compensating module, configured to obtain, based on a difference between the current concentration and a predetermined concentration, a first compensation amount of the first solution to be compensated to the mixing device or a second compensation amount of the second solution to be compensated to the mixing device, and to compensate the mixed solution based on the first compensation amount or the second compensation amount so that the concentration of the compensated solution reaches the predetermined concentration.

In order to make the objectives, technical solutions, and advantages of the embodiments of the present disclosure more clear, various embodiments of the present disclosures will be detailed below in combination with the accompanying drawings. However, a person of ordinary skill in the art can understand that in each embodiment of the present disclosure, many technical details are provided for readers to better understand the present disclosure. However, even if these technical details are not provided and based on variations and modifications of the following embodiments, the technical solutions sought for protection in the present disclosure can also be implemented.

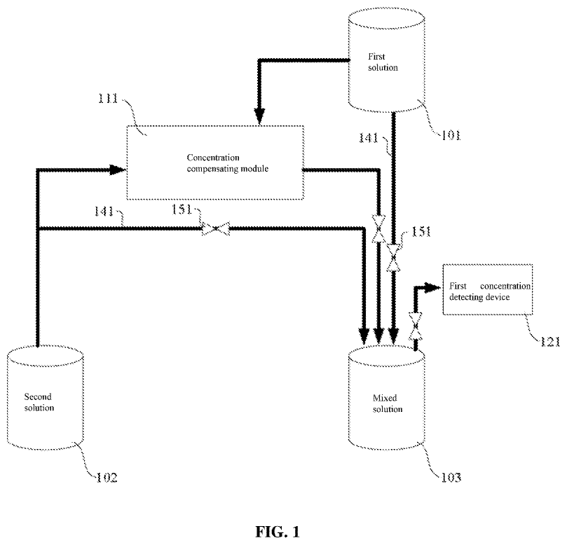

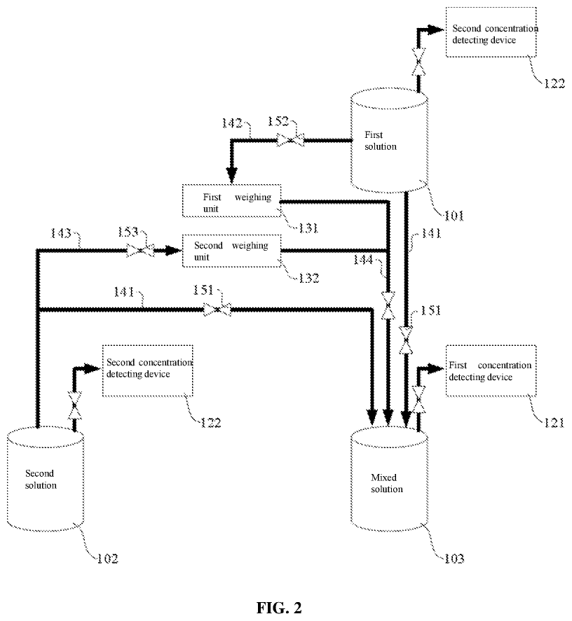

A first embodiment of the present disclosure provides a monitoring feedback system. The monitoring feedback system according to this embodiment will be described in detail below with reference to the accompanying drawings. FIGS. 1 to 2 are schematic structural diagrams of a monitoring feedback system according to a first embodiment of the present disclosure.

Referring to FIG. 1, in this embodiment, the monitoring feedback system comprises: a first accommodating device 101 and a second accommodating device 102, respectively configured to store a first solution and a second solution; a mixing device 103, configured to store a mixed solution, the mixed solution being composed of the first solution and the second solution; a first concentration detecting device 121, configured to detect a current concentration of the mixed solution; and a concentration compensating module 111, configured to obtain, based on a difference between the current concentration and a predetermined concentration, a first compensation amount of the first solution to be compensated to the mixing device 103 or a second compensation amount of the second solution to be compensated to the mixing device 103, and to compensate the mixed solution based on the first compensation amount or the second compensation amount so that the concentration of the compensated solution reaches the predetermined concentration.

Specifically, the first concentration detecting device 121 detects the current concentration of the mixed solution. The current concentration here may be a concentration of the first solution in the mixed solution or a concentration of the second solution in the mixed solution.

It can be understood that if the current concentration of the first solution in the mixed solution is detected and when the current concentration is greater than the predetermined concentration, the required second compensation amount of the second solution is calculated according to the difference between the current concentration and the predetermined concentration so that the current concentration is equal to the predetermined concentration; when the current concentration is less than the predetermined concentration, the required first compensation amount of the first solution is calculated according to the difference between the current concentration and the predetermined concentration so that the current concentration is equal to the predetermined concentration. If the current concentration of the second solution in the mixed solution is detected and when the current concentration is greater than the predetermined concentration, the required first compensation amount of the first solution is calculated according to the difference between the current concentration and the predetermined concentration so that the current concentration is equal to the predetermined concentration; when the current concentration is less than the predetermined concentration, the required second compensation amount of the second solution is calculated according to the difference between the current concentration and the predetermined concentration so that the current concentration is equal to the predetermined concentration. Moreover, the required first compensation amount of the first solution and the required second compensation amount of the second solution can also be calculated according to actual needs, so that the current concentration is equal to the predetermined concentration.

It should be noted that, in this embodiment, by the concentration compensating module 111, the concentration after compensation can be equal to the predetermined concentration. In other embodiments, the concentration after compensation also can be close to the predetermined concentration as required. In an example, the concentration of the first solution of the mixed solution can fall within a range of ±5% of the predetermined concentration, for example, within a range of ±4%, ±3%, ±2%, or ±1%.

Referring to FIG. 2, in this embodiment, the monitoring feedback system further includes: two diluting pipes 141, the diluting pipes 141 are respectively connected between the first accommodating device 101 and the mixing device 103 and between the second accommodating device 102 and the mixing device 103.

It can be understood that when the first solution and the second solution are initially mixed to form the mixed solution, the first solution and the second solution are respectively introduced into the mixing device 103 through the diluting pipes 141 to form the mixed solution.

In this embodiment, the monitoring feedback system further includes: first valves 151 located on the diluting pipes 141 and configured to control the on and off of the diluting pipes 141.

The first valve 151 is configured to control the on and off of the diluting pipe 141, that is, the first valve 151 is configured to control whether the first solution or the second solution is introduced into the mixing device 103.

It should be noted that, in this embodiment, the first solution is deionized water (DIW), the second solution is a chemical product, and the mixed solution formed in the mixing device 103 is a diluted chemical product. In other embodiments, the first solution and the second solution may be any liquids, that is, the mixed solution in the mixing device is a mixed solution composed of any first solution and any second solution.

When the first concentration detecting device 121 detects the concentration of the chemical product, the detected concentration is often not very accurate due to the volatility of the chemical product. Therefore, the first concentration detecting device 121 needs to be maintained in a sealed state.

During the concentration detection for the chemical product, an acid solution with a known concentration and a known volume can be added in advance to undergo a complete neutralization reaction with the chemical product until the chemical product is completely reacted, and then the concentration of the remaining acid solution is detected, and the concentration of chemical product can also be calculated.

In this embodiment, the acid solution is hydrochloric acid, and a 1 mol/L hydrochloric acid solution needs to be prepared for detecting the concentration of the chemical product. Firstly, sodium carbonate was dried at a temperature between 100° C. and 105° C. for 2 h for concentration calibration of the 1 mol/L hydrochloric acid solution; 90 to 95 ml of a hydrochloric acid solution with a concentration of 36% was added to a 1 L volumetric flask, ultrapure water was then added to 1 L, and the solution was mixed thoroughly; the dried sodium carbonate was used to calibrate the hydrochloric acid solution, and the same operation was repeated 6 times; the average value was recorded as the concentration of the hydrochloric acid solution.

50 to 60 ml of ultrapure water was added to a reaction vessel of the first concentration detecting device 121, then 20 ml of a hydrochloric acid solution was added, 0.5 g of a chemical product was extracted and allowed to fully react in the reaction vessel, and finally the concentration of the remaining hydrochloric acid solution in the reaction vessel was detected by using a sodium hydroxide solution with a known concentration and the concentration of the chemical product was then calculated.

It should be noted that the above specific data is an example of specific values to illustrate the principle of supplementary injection in this embodiment, which is convenient for those skilled in the art to understand this solution and does not constitute a limitation on this embodiment.

In this embodiment, the concentration compensating module 111 further includes: a first weighing unit 131 connected to the first accommodating device 101 and configured to weigh the first solution so that an amount of the compensated first solution is equal to the first compensation amount; and a second weighing unit 132 connected to the second accommodating device 102 and configured to weigh the second solution so that an amount of the compensated second solution is equal to the second compensation amount.

The first solution is weighed by the first weighing unit 131 to obtain the first compensation amount, or the second solution is weighed by the second weighing unit 132 to obtain the second compensation amount.

It should be noted that the first weighing unit 131 and the second weighing unit 132 are weighing devices with a relatively high accuracy, so as to be able to accurately weigh the required first compensation amount or the required second compensation amount.

In this embodiment, the monitoring feedback system further includes: a first compensating pipe 142 connected between the first accommodating device 101 and the mixing device 103; and a second compensating pipe 143 connected between the second accommodating device 102 and the mixing device 103; the first weighing unit 131 is connected to the first compensating pipe 142, and the second weighing unit 132 is connected to the second compensating pipe 143.

It can be understood that when the mixed solution needs to be compensated, the compensated first solution passes the first weighing unit 131 through the first compensating pipe 142, and the first solution is then weighed to obtain the required first compensation amount; the compensated second solution passes the second weighing unit 132 through the second compensating pipe 143, and the second solution is then weighed to obtain the required second compensation amount.

In this embodiment, the monitoring feedback system further includes: a merging pipe 144 by which the first compensating pipe 142 is connected to the mixing device 103 and also by which the second compensating pipe 143 is connected to the mixing device 103.

The first compensation amount of the solution is introduced in the mixing device 103 from the first compensating pipe 142 to the merging pipe 144, and the second compensation amount of the solution is introduced in the mixing device 103 from the second compensating pipe 143 to the merging pipe 144.

In other embodiments, mixing pipes can also be arranged separately.

It can be understood that the monitoring feedback system further includes: a second valve 152 arranged on the first compensating pipe 142 between the first accommodating device 101 and the first weighing unit 131; and a third valve 153 arranged on the second compensating pipe 143 between the second accommodating device 102 and the second weighing unit 132.

Correspondingly, the first compensating pipe 142 between the first accommodating device 101 and the first weighing unit 131 is provided with the second valve 152 for controlling the amount of the first solution introduced into the first weighing unit 131 to reach the first compensation amount; and when the amount of the first solution introduced into the first weighing unit 131 reaches the first compensation amount, the first compensating pipe 142 is cut off through the second valve 152. The second compensating pipe 143 between the second accommodating device 102 and the second weighing units 132 is provided with the third valve 153 for controlling the amount of the second solution introduced into the second weighing unit 132 to reach the second compensation amount; and when the amount of the second solution introduced in the second weighing unit 132 reaches the second compensation amount, the second compensating pipe 143 is cut off through the third valve 153.

In this embodiment, the monitoring feedback system further includes: a second concentration detecting device 122 for detecting the concentration of the first solution in the first accommodating device 101, or for detecting the concentration of the second solution in the second accommodating device 102.

It can be understood that the second concentration detecting device 122 can detect the concentration of the first solution or the concentration of the second solution in real time. The concentration compensating module 1111 calculates a more accurate required first compensation amount or second compensation amount according to the real-time concentration of the first solution or the real-time concentration of the second solution. When the first solution and the second solution are mixed to form the mixed solution, an appropriate ratio can also be calculated more accurately according to the concentration of the first solution and the concentration of the second solution.

In the monitoring feedback system and the monitoring feedback method according to the embodiments of the present disclosure, a real-time concentration detecting device is configured to replace manual detection in the prior art, thereby improving the efficiency of concentration detection and also reducing manual operations and potential safety hazards caused by the manual operations; due to arrangement of the concentration compensating module, the solution mixing process is optimized, the cost caused for disposing of a mixed solution with an unqualified solution when the concentration of the mixed solution is not equal to the predetermined concentration is reduced, and the success rate of solution preparation is further improved.

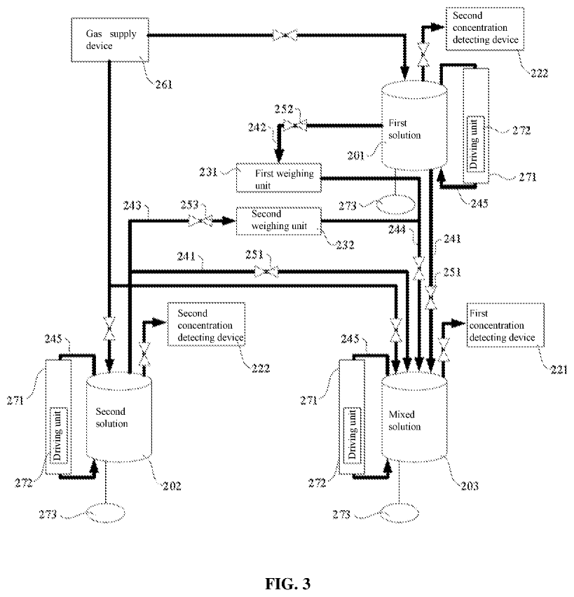

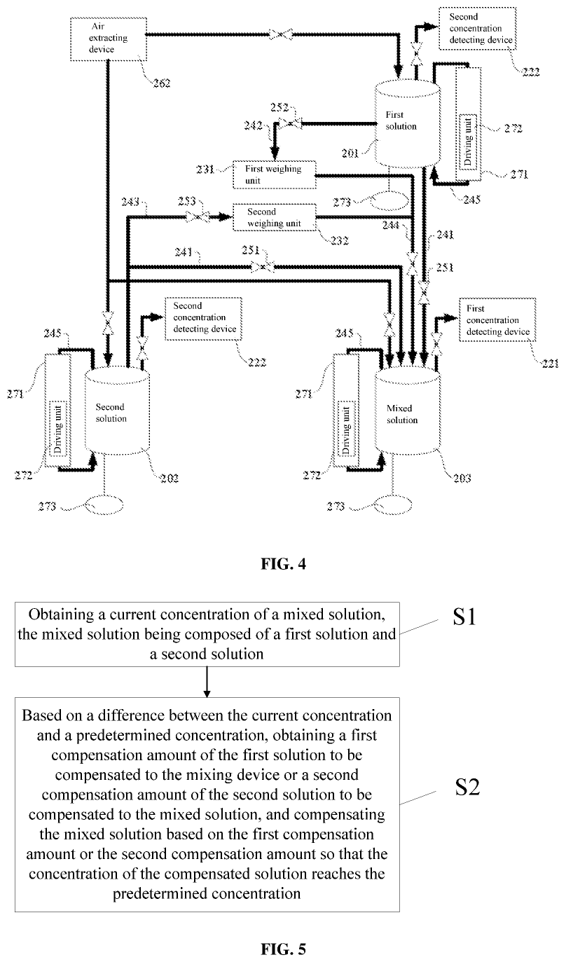

A second embodiment of the present disclosure further provides a monitoring feedback system. A pairing method according to the second embodiment of the present disclosure will be described in detail below with reference to the accompanying drawings. For the same or corresponding parts in this embodiment as in the previous embodiment, reference may be made to the description of the foregoing embodiment and it will not be repeated hereafter. FIGS. 3 to 4 are schematic structural diagrams of a monitoring feedback system according to a second embodiment of the present disclosure.

Referring to FIG. 3, in this embodiment, the monitoring feedback system includes: a first accommodating device 201, a second accommodating device 202, a mixing device 203, two diluting pipes 241, two first valves 251 located on the diluting pipes 241, a first weighing unit 231, a second weighing unit 232, a first compensating pipe 242, a second compensating pipe 243, a merging pipe 244, a second valve 252 located on the first compensating pipe, a third valve 253 located on the second compensating pipe, a first concentration detecting device 221, and a second concentration detecting device 222. The monitoring feedback system further comprises: a gas supply device 261, configured to supply N2 or an inert gas for at least one of the first accommodating device 201, the second accommodating device 202, and the mixing devices 203 through a gas supply pipe.

Specifically, since the first accommodating device 201, the second accommodating device 202, the mixing device 203, the diluting pipe 241, the first compensating pipe 242, the second compensating pipe 243, and the merging pipe 244 are not full filled with liquid, and a first solution, a second solution, and a mixed solution are in an environment in contact with the air. For some chemical products, when the chemical products come into contact with the air, carbon dioxide in the air will gradually chemically react with the chemical products, causing chemical product contamination and changes in concentration.

In this embodiment, the gas supply device 261 provides N2 or an inert gas for the monitoring feedback system, which can prevent solutions in the system from reacting with carbon dioxide in the air.

In another example, referring to FIG. 4, the monitoring feedback system further includes: an air extracting device 262 in communication with at least one of the first accommodating device 201, the second accommodating device 202, and the mixing device 203.

In order to prevent the solution from contacting and reacting with air and causing solution contamination, an air extracting device can also be used to maintain a vacuum in the monitoring feedback system.

In this embodiment, the monitoring feedback system further includes: a circulating device 271, configured to circulate liquid in at least one of the first accommodating device 201, the second accommodating device 202, and the mixing device 203.

It can be understood that the concentration of a solution may be uneven after the solution is rested for a long time, and the concentration detected directly in this case may be inaccurate. The circulating device 271 is arranged on the first accommodating device 201, the second accommodating device 202 or the mixing device 203 to circulate liquid therein, so as to obtain more accurate concentration data.

The circulating device 271 includes: a circulating pipe 245, two ends of the circulating pipe 245 being respectively connected to at least one of the first accommodating device 201, the second accommodating device 202 and the mixing device 203; a driving unit 272, configured to drive the liquid to circulate and flow through the circulating pipe 245; and a liquid level sensor 273, configured to detect liquid level information of the liquid in at least one of the first accommodating device 201, the second accommodating device 202, and the mixing device 203; wherein the driving unit 702 controls a flow rate and required duration of liquid circulation according to the liquid level information.

The liquid level sensor 273 can detect the liquid level information of the liquid in the first accommodating device 201, the second accommodating device 202 or the mixing device 203 in real time, and the driving unit 272 controls the flow rate and circulation duration of the circulating device according to the liquid level information, thus avoiding a problem of uneven mixing due to insufficient circulation time or a problem of unnecessary time waste due to overlong circulation time.

The monitoring feedback system according to the embodiment of the present application improves the efficiency of concentration detection, optimizes the solution mixing process, and further improves the success rate of solution preparation. By the addition of the gas supply device, the gas extraction device, or the circulating device, the monitoring feedback system is optimized, the solution can be prevented from contacting and reacting with the air, and moreover concentration detection errors caused by uneven concentration in the solution can be avoided.

A third embodiment of the present disclosure further provides a monitoring feedback method. A pairing method according to the second embodiment of the present disclosure will be described in detail below with reference to the accompanying drawings. For the same or corresponding parts in this embodiment as in the previous embodiment, reference may be made to the description of the foregoing embodiment and it will not be repeated hereafter. FIG. 5 is a schematic step diagram of a monitoring feedback method according to a third embodiment of the present disclosure.

Referring to FIG. 5, in step S1, a current concentration of a mixed solution is obtained, and the mixed solution is composed of a first solution and a second solution.

Specifically, the obtained concentration of the mixed solution may be a concentration of the first solution in the mixed solution or a concentration of the second solution in the mixed solution.

A ratio of the mixed solution is obtained according to the concentration of the first solution and the concentration of the second solution. Since the concentration of a solution will become uneven after the solution is rested for a long time, the liquids of the first solution and the second solution should be fully circulated during the preparation of the mixed solution to ensure an even internal concentration and obtain accurate concentration data. The ratio of the mixed solution is then calculated according to the concentration of the first solution and the concentration of the second solution, and the best effort is made to ensure that the concentration of the mixed solution is equal to a predetermined concentration, thus reducing subsequent compensation work.

Before liquid circulation, the flow rate of the liquid circulation and the required circulation duration are circulated according to liquid level information of the liquid, so as to avoid the problem of uneven liquid concentration due to insufficient circulation time or the problem of overlong circulation time.

The mixed solution may also have uneven concentration, and in this case the detected concentration is often inaccurate. Therefore, before the current concentration of the mixed solution is obtained, the liquid of the mixed solution should be fully circulated.

Referring to FIG. 5 again, in step 2, based on a difference between the current concentration and the predetermined concentration, a first compensation amount of the first solution to be compensated to the mixed solution or a second compensation amount of the second solution to be compensated to the mixed solution is obtained, and based on the first compensation amount or the second compensation amount, the mixed solution is compensated so that the concentration of the compensated solution reaches the predetermined concentration.

According to the difference between the current concentration and the predetermined concentration, a required compensation amount of the first solution or a required compensation amount of the second solution is calculated.

It can be understood that if the current concentration of the first solution in the mixed solution is obtained and when the current concentration is greater than the predetermined concentration, the required second compensation amount of the second solution is calculated according to the difference between the current concentration and the predetermined concentration so that the current concentration is equal to the predetermined concentration; when the current concentration is less than the predetermined concentration, the required first compensation amount of the first solution is calculated according to the difference between the current concentration and the predetermined concentration so that the current concentration is equal to the predetermined concentration. If the current concentration of the second solution in the mixed solution is obtained and when the current concentration is greater than the predetermined concentration, the required first compensation amount of the first solution is calculated according to the difference between the current concentration and the predetermined concentration so that the current concentration is equal to the predetermined concentration; when the current concentration is less than the predetermined concentration, the required second compensation amount of the second solution is calculated according to the difference between the current concentration and the predetermined concentration so that the current concentration is equal to the predetermined concentration. Moreover, the required first compensation amount of the first solution and the required second compensation amount of the second solution can also be calculated respectively according to actual needs, so that the current concentration is equal to the predetermined concentration.

It should be noted that, in this embodiment, by the concentration compensation, the concentration after compensation can be equal to the predetermined concentration. In other embodiments, the concentration after compensation can also be close to the predetermined concentration as required. In an example, the concentration of the first solution of the mixed solution can fall within a range of ±5% of the predetermined concentration, for example, within a range of ±4%, ±3%, ±2%, or ±1%.

The first solution to be compensated is weighed to obtain the first solution with the first compensation amount; the second solution to be compensated is weighed to obtain the second solution with the second compensation amount.

Specifically, the required compensation amount is calculated according to the real-time concentration of the first solution or the second solution, so that an obtained compensation parameter can be more accurate.

In this embodiment, the first compensation amount and the second compensation amount also need to be calculated according to the concentration of the first solution and the concentration of the second solution. Here, in order to obtain an accurate concentration value, before the concentration is obtained, the first solution and the second solution also should be fully circulated to make their internal concentrations even.

It should be noted that in this embodiment, the first solution is DIW, the second solution is a chemical product, and the mixed solution formed is a diluted chemical product. In other embodiments, the first solution and the second solution may be any liquids, that is, the mixed solution is a mixed solution composed of any first solution and any second solution.

During the process of obtaining the concentration of the chemical product, the obtained concentration is often not very accurate due to the volatility of the chemical product. Therefore, the concentration of the solution must be obtained in a sealed environment.

An acid solution with a known concentration and a known volume can be added in advance to undergo a complete neutralization reaction with the chemical product until the chemical product is completely reacted, and then the concentration of the remaining acid solution is detected, and the concentration of chemical product can also be calculated.

In this embodiment, the acid solution is hydrochloric acid, and a 1 mol/L hydrochloric acid solution needs to be provided for detecting the concentration of the chemical product. Firstly, sodium carbonate dried at a temperature between 100° C. and 105° C. for 2 h was provided for concentration calibration of the 1 mol/L hydrochloric acid solution; 90 to 95 ml of a hydrochloric acid solution with a concentration of 36% was added to a 1 L volumetric flask, ultrapure water was then added to 1 L, and the solution was mixed thoroughly; the dried sodium carbonate was used to calibrate the hydrochloric acid solution, and the same operation was repeated 6 times, and the average value was recorded as the concentration of the hydrochloric acid solution.

50 to 60 ml of ultrapure water was added to a reaction vessel of the concentration detecting device, then 20 ml of the hydrochloric acid solution was added, 0.5 g of a chemical product was extracted and allowed to fully react in the reaction vessel, and finally the concentration of the remaining hydrochloric acid solution in the reaction vessel was detected by using a sodium hydroxide solution with a known concentration and the concentration of the chemical product was then calculated.

It should be noted that the above specific data is an example of specific values to illustrate the principle of supplementary injection in this embodiment, which is convenient for those skilled in the art to understand this solution and does not constitute a limitation on this embodiment.

Since the devices for accommodating the first solution, the second solution and the mixed solution are not full filled, the solutions are in an environment in contact with the air for a long time. For some chemical products, when the chemical products come into contact with the air for a long time, carbon dioxide in the air will gradually chemically react with the chemical products, causing chemical product contamination and changes in concentration. In this embodiment, by providing N2 or an inert gas for the devices, the solutions can be prevented from reacting with carbon dioxide in the air.

It can be understood that, in order to prevent the solutions from contacting and reacting with the air and causing solution contamination, an air extracting device can also be used to maintain a vacuum in the devices for accommodating the solutions.

The monitoring feedback method according to the embodiments of the disclosure can detect solution concentration in real time, and calculate the required solution compensation amount according to the difference between the current concentration of the solution and the predetermined concentration, thereby improving the efficiency of concentration detection, reducing manual operations and potential safety hazards caused by the manual operations, optimizing the solution mixing process, and further improving the success rate of solution preparation.

The ordinary skills in the art can understand that the implementations described above are particular embodiments for implementing the present application. In practical uses, various changes in forms and details may be made to the implementations without departing from the spirit and scope of the present application. Any person skilled in the art may make their own changes and modifications without departing from the spirit and scope of the present disclosure. Therefore, the protection scope of the present disclosure shall be subject to the protection scope of the claims.

What is claimed is:

1. A monitoring feedback system, comprising:
a first accommodating device and a second accommodating device, configured to store a first solution and a second solution respectively;
a mixing device, configured to store a mixed solution, the mixed solution being composed of the first solution and the second solution;
a first concentration detecting device, configured to detect a current concentration of the mixed solution; and
a concentration compensating module, configured to obtain, based on a difference between the current concentration and a predetermined concentration, a first compensation amount of the first solution to be compensated to the mixing device or a second compensation amount of the second solution to be compensated to the mixing device, and to compensate the mixed solution based on the first compensation amount or the second compensation amount so that the concentration of the compensated solution reaches the predetermined concentration.

2. The monitoring feedback system according to claim 1, wherein the concentration compensating module comprises:
a first weighing unit connected to the first accommodating device and configured to weigh the first solution so that an amount of the compensated first solution is equal to the first compensation amount; and
a second weighing unit connected to the second accommodating device and configured to weigh the second solution so that an amount of the compensated second solution is equal to the second compensation amount.

3. The monitoring feedback system according to claim 2, further comprising:
two diluting pipes, the diluting pipes being respectively connected between the first accommodating device and the mixing device and between the second accommodating device and the mixing device.

4. The monitoring feedback system according to claim 3, further comprising: a first compensating pipe connected between the first accommodating device and the mixing device; and
a second compensating pipe connected between the second accommodating device and the mixing device, wherein the first weighing unit is connected to the first compensating pipe, and the second weighing unit is connected to the second compensating pipe.

5. The monitoring feedback system according to claim 1, further comprising:
a second concentration detecting device for detecting a concentration of the first solution in the first accommodating device, or for detecting a concentration of the second solution in the second accommodating device.

6. The monitoring feedback system according to claim 1, further comprising:
a gas supply device, configured to supply N₂ or an inert gas for at least one of the first accommodating device, the second accommodating device, or the mixing devices through a gas supply pipe.

7. The monitoring feedback system according to claim 1, further comprising:
an air extracting device in communication with at least one of the first accommodating device, the second accommodating device, and the mixing device.

8. The monitoring feedback system according to claim 1, further comprising:
a circulating device, configured to circulate liquid in at least one of the first accommodating device, the second accommodating device, or the mixing device, the circulating device comprising: a circulating pipe, two ends of the circulating pipe being respectively connected to at least one of the first accommodating device, the second accommodating device, or the mixing device; a driving unit, configured to drive the liquid to circulate and flow through the circulating pipe; and a liquid level sensor, configured to detect liquid level information of the liquid in at least one of the first accommodating device, the second accommodating device, or the mixing device, the driving unit controlling a flow rate and required duration of the liquid circulation based on the liquid level information.

9. A monitoring feedback method, comprising:
obtaining a current concentration of a mixed solution, the mixed solution being composed of a first solution and a second solution; and
based on a difference between the current concentration and a predetermined concentration, obtaining a first compensation amount of the first solution to be compensated to a mixing device or a second compensation amount of the second solution to be compensated to the mixed solution, and compensating the mixed solution based on the first compensation amount or the second compensation amount so that the concentration of the compensated solution reaches the predetermined concentration.

10. The monitoring feedback method according to claim 9, further comprising:
weighing the first solution to be compensated to obtain the first solution with the first compensation amount; and
weighing the second solution to be compensated to obtain the second solution with the second compensation amount.
